(19) United States
(12) Patent Application Publication
(10) Pub. No.: US 2024/0080700 A1
(43) Pub. Date: Mar. 7, 2024

(54) INFORMATION PROCESSING METHOD AND APPARATUS, TERMINAL, AND NETWORK SIDE DEVICE

(71) Applicant: VIVO MOBILE COMMUNICATION CO., LTD., Dongguan (CN)

(72) Inventor: Peng SUN, Dongguan (CN)

(73) Assignee: VIVO MOBILE COMMUNICATION CO., LTD., Dongguan (CN)

(21) Appl. No.: 18/507,052

(22) Filed: Nov. 12, 2023

Related U.S. Application Data
(63) Continuation of application No. PCT/CN2022/092202, filed on May 11, 2022.

(30) Foreign Application Priority Data
May 12, 2021 (CN) 202110519209.9

(51) Int. Cl. H04W 24/10; H04B 7/0408; H04B 7/06

(52) U.S. Cl. CPC H04W 24/10; H04B 7/0408; H04B 7/0632

(57) ABSTRACT

This application discloses an information processing method, including: receiving, by a terminal, first information sent by a first device entity, where the first information includes at least one of the following: first sub-information used to indicate a first processing method; first assistance information used for the first processing method; result information obtained by performing processing based on a second processing method; an indication used to request second sub-information, where the second sub-information is terminal-related information or information obtained by performing information feature hiding on the terminal-related information; or an indication used to request third sub-information, where the third sub-information is used to update a third processing method, where the first information or an operation performed according to the first information is used to determine at least one of the following: beam or channel measurement, beam or channel measurement reporting, and a beam or channel prediction-related operation.

### CROSS-REFERENCE TO RELATED APPLICATIONS

This application is a continuation of International Application No. PCT/CN2022/092202, filed May 11, 2022, which claims priority to Chinese Patent Application No. 202110519209.9, filed May 12, 2021. The entire contents of each of the above-referenced applications are expressly incorporated herein by reference.

### TECHNICAL FIELD

This application relates to the field of communication technologies, and in particular, to an information processing method and apparatus, a terminal, and a device entity.

### BACKGROUND

In a communication system, the communication state of a terminal is determined by a network side device generally. The network side device generally configures a related measurement configuration for the terminal according to only related information of a base station, to control the terminal to perform beam measurement and beam measurement reporting and adjust the communication state of the terminal. Due to the communication state of the terminal is adjusted based on only the related information of the base station, air interface performance of communication is poor.

### SUMMARY

Embodiments of this application provide an information processing method and apparatus, a terminal, and a device entity.

According to a first aspect, an information processing method is provided, including:
receiving, by a terminal, first information sent by a first device entity, where the first information includes at least one of the following:
first sub-information used to indicate the first processing method;
first assistance information used for the first processing method;
result information obtained by performing processing based on a second processing method;
an indication used to request second sub-information, where the second sub-information is terminal-related information or information obtained by performing information feature hiding on the terminal-related information; or
an indication used to request third sub-information, where the third sub-information is used to update a third processing method, where
the first information or an operation performed according to the first information is used to determine at least one of the following: beam or channel measurement, beam or channel measurement reporting, or a beam or channel prediction-related operation.

According to a second aspect, an information processing method is provided. including:
sending, by a first device entity, first information to a terminal, where the first information includes at least one of the following:
first sub-information used to indicate the first processing method;
first assistance information used for the first processing method;
result information obtained by performing processing based on a second processing method;
an indication used to request second sub-information, where the second sub-information is terminal-related information or information obtained by performing information feature hiding on the terminal-related information; or
an indication used to request third sub-information, where the third sub-information is used to update a third processing method, where
the first information or an operation performed according to the first information is used to determine at least one of the following: beam or channel measurement, beam or channel measurement reporting, or a beam or channel prediction-related operation.

According to a third aspect, an information processing method is provided, including:
sending, by a second device entity, first target information to a first device entity, where the first target information includes related information of the second device entity or information obtained by performing second preset processing on the related information of the second device entity, and the first target information is used to determine first information sent by the first device entity to a terminal, where
the first information includes at least one of the following:
first sub-information used to indicate the first processing method;
first assistance information used for the first processing method; or
result information obtained by performing processing based on a second processing method, where
the first information or an operation performed according to the first information is used to determine at least one of the following: beam or channel measurement, beam or channel measurement reporting, or a beam or channel prediction-related operation.

According to a fourth aspect, an information processing method is provided, including:
sending, by a first device entity, first information to a terminal; and
receiving, by the terminal, the first information, where the first information includes at least one of the following:
first sub-information used to indicate the first processing method;
first assistance information used for the first processing method;
result information obtained by performing processing based on a second processing method;
an indication used to request second sub-information, where the second sub-information is terminal-related information or information obtained by performing information feature hiding on the terminal-related information; or
an indication used to request third sub-information, where the third sub-information is used to update a third processing method, where
the first information or an operation performed according to the first information is used to determine at least one of the following: beam or channel measurement, beam or channel measurement reporting, or a beam or channel prediction-related operation.

According to a fifth aspect, an information processing apparatus is provided, including:
a first receiving module, configured to receive first information sent by a first device entity, where the first information includes at least one of the following:
first sub-information used to indicate the first processing method;
first assistance information used for the first processing method;
result information obtained by performing processing based on a second processing method;
an indication used to request second sub-information, where the second sub-information is terminal-related information or information obtained by performing information feature hiding on the terminal-related information; or
an indication used to request third sub-information, where the third sub-information is used to update a third processing method, where
the first information or an operation performed according to the first information is used to determine at least one of the following: beam or channel measurement, beam or channel measurement reporting, or a beam or channel prediction-related operation.

According to a sixth aspect, an information processing apparatus is provided, including:
a second sending module, configured to perform first information to a terminal, where the first information includes at least one of the following:
first sub-information used to indicate the first processing method;
first assistance information used for the first processing method;
result information obtained by performing processing based on a second processing method;
an indication used to request second sub-information, where the second sub-information is terminal-related information or information obtained by performing information feature hiding on the terminal-related information; or
an indication used to request third sub-information, where the third sub-information is used to update a third processing method, where
the first information or an operation performed according to the first information is used to determine at least one of the following: beam or channel measurement, beam or channel measurement reporting, or a beam or channel prediction-related operation.

According to a seventh aspect, an information processing apparatus is provided, including:
a third sending module, configured to send first target information to a first device entity, where the first target information includes related information of the second device entity or information obtained by performing second preset processing on the related information of the second device entity, and the first target information is used to determine first information sent by the first device entity to a terminal, where
the first information includes at least one of the following:
first sub-information used to indicate the first processing method;
first assistance information used for the first processing method; or
result information obtained by performing processing based on a second processing method, where
the first information or an operation performed according to the first information is used to determine at least one of the following: beam or channel measurement, beam or channel measurement reporting, or a beam or channel prediction-related operation.

According to an eighth aspect, an information processing system is provided, including:
a first device entity, configured to send first information to a terminal; and
a terminal, configured to receive the first information, where the first information includes at least one of the following:
first sub-information used to indicate the first processing method;
first assistance information used for the first processing method;
result information obtained by performing processing based on a second processing method;
an indication used to request second sub-information, where the second sub-information is terminal-related information or information obtained by performing information feature hiding on the terminal-related information; or
an indication used to request third sub-information, where the third sub-information is used to update a third processing method, where
the first information or an operation performed according to the first information is used to determine at least one of the following: beam or channel measurement, beam or channel measurement reporting, or a beam or channel prediction-related operation.

According to a ninth aspect, a terminal is provided. The terminal includes a processor, a memory, and a program or an instruction that is stored in the memory and that can be run on the processor, where when the program or the instruction is executed by the processor, the steps of the method in the first aspect are implemented.

According to a tenth aspect, a terminal is provided, including a processor and a communication interface, where
the communication interface is configured to receive first information sent by a first device entity, where the first information includes at least one of the following:
first sub-information used to indicate the first processing method;
first assistance information used for the first processing method;
result information obtained by performing processing based on a second processing method;
an indication used to request second sub-information, where the second sub-information is terminal-related information or information obtained by performing information feature hiding on the terminal-related information; or
an indication used to request third sub-information, where the third sub-information is used to update a third processing method, where
the first information or an operation performed according to the first information is used to determine at least one of the following: beam or channel measurement, beam or channel measurement reporting, or a beam or channel prediction-related operation.

According to an eleventh aspect, a network side device is provided. The network side device includes a processor, a memory, and a program or an instruction that is stored in the memory and that can be run on the processor, where the program or the instruction is executed by the processor to implement the steps of the method in the second aspect or the steps of the method in the third aspect.

According to a twelfth aspect, a network side device is provided, including a processor and a communication interface, where
the communication interface is configured to send first information to a terminal, where the first information includes at least one of the following:
first sub-information used to indicate the first processing method;
first assistance information used for the first processing method;
result information obtained by performing processing based on a second processing method;
an indication used to request second sub-information, where the second sub-information is terminal-related information or information obtained by performing information feature hiding on the terminal-related information; or
an indication used to request third sub-information, where the third sub-information is used to update a third processing method, where
the first information or an operation performed according to the first information is used to determine at least one of the following: beam or channel measurement, beam or channel measurement reporting, or a beam or channel prediction-related operation.

In some embodiments, the communication interface is configured to send first target information to a first device entity, where the first target information includes related information of the second device entity or information obtained by performing second preset processing on the related information of the second device entity, and the first target information is used to determine first information sent by the first device entity to a terminal, where
the first information includes at least one of the following:
first sub-information used to indicate the first processing method;
first assistance information used for the first processing method; or
result information obtained by performing processing based on a second processing method, where
the first information or an operation performed according to the first information is used to determine at least one of the following: beam or channel measurement, beam or channel measurement reporting, or a beam or channel prediction-related operation.

According to a thirteenth aspect, a readable storage medium is provided. The readable storage medium stores a program or an instruction, and the program or the instruction is executed by a processor to implement the steps of the method in the first aspect or the steps of the method in the second aspect or the steps of the method in the third aspect.

According to a fourteenth aspect, an embodiment of this application provides a chip. The chip includes a processor and a communication interface, the communication interface is coupled to the processor, and the processor is configured to run a program or an instruction to implement the steps of the method in the first aspect, or the steps of the method in the second aspect, or the steps of the method in the third aspect.

According to a fifteenth aspect, a computer program product is provided. The computer program product is stored in a storage medium, and the computer program product is executed by at least one processor to implement the method in the first aspect, or the method in the second aspect, or the steps of the method in the third aspect.

In the embodiments of this application, a terminal receives first information sent by a first device entity, where the first information includes at least one of the following: first sub-information used to indicate the first processing method; first assistance information used for the first processing method; result information obtained by performing processing based on a second processing method; an indication used to request second sub-information, where the second sub-information is terminal-related information or information obtained by performing information feature hiding on the terminal-related information, or an indication used to request third sub-information, where the third sub-information is used to update the second processing method, where the first information or an operation performed according to the first information is used to determine at least one of the following: beam or channel measurement, beam or channel measurement reporting, or a beam or channel prediction-related operation. In this way, at least one of the following is determined by using the first information: beam or channel measurement, beam or channel measurement reporting, or a beam or channel prediction-related operation. Therefore, in the embodiments of this application, air interface performance can be improved.

### BRIEF DESCRIPTION OF DRAWINGS

FIG. 1 is a structural diagram of a network system to which the embodiments of this application can be applied;

FIG. 2 is a first flowchart of an information processing method according to an embodiment of this application;

FIG. 3 is a second flowchart of an information processing method according to an embodiment of this application;

FIG. 4 is a third flowchart of an information processing method according to an embodiment of this application:

FIG. 5 is a fourth flowchart of an information processing method according to an embodiment of this application;

FIG. 6 is a first structural diagram of an information processing apparatus according to an embodiment of this application;

FIG. 7 is a second structural diagram of an information processing apparatus according to an embodiment of this application;

FIG. 8 is a third structural diagram of an information processing apparatus according to an embodiment of this application;

FIG. 9 is a structural diagram of a communication device according to an embodiment of this application;

FIG. 10 is a structural diagram of a terminal according to an embodiment of this application; and

FIG. 11 is a structural diagram of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

In the specification and claims of this application. the terms “first”, “second”, and the like are intended to distinguish between similar objects but do not describe a specific order or sequence. It should be understood that, the terms used in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the specification and the claims, “and/or” represents at least one of connected objects, and a character “/” generally represents an “or” relationship between associated objects.

It should be noted that, the technologies described in the embodiments of this application are not limited to a Long Term Evolution (LTE)/LTE-Advanced (LTE-A) system, and can also be used in other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and another system. The terms “system” and “network” in the embodiments of this application may be used interchangeably. The technologies described can be applied to both the systems and the radio technologies mentioned above as well as to other systems and radio technologies. The following descriptions describe a New Radio (NR) system for example purposes, and NR terms are used in most of the following descriptions, but these technologies can also be applied to an application other than an NR system application, for example, a 6^{th} generation (6G) communication system.

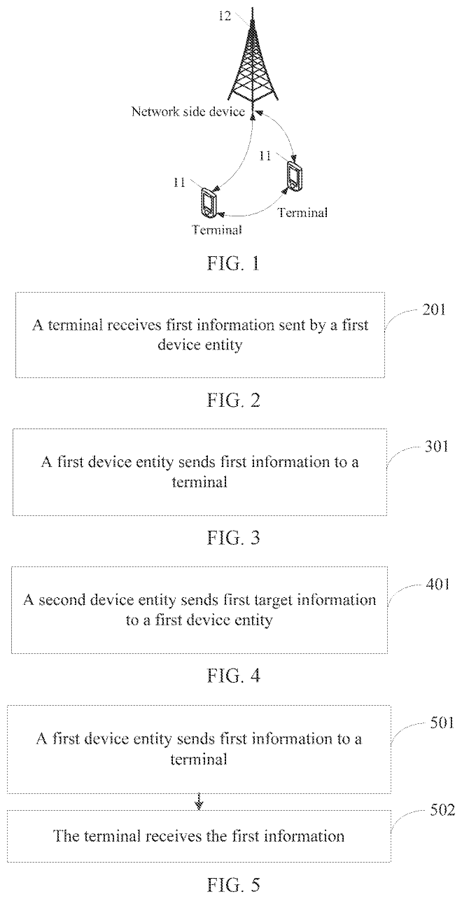

FIG. 1 is a block diagram of a wireless communication system to which embodiments of this application can be applied. The wireless communication system includes a terminal 11 and a network side device 12. The terminal 11 may also be referred to as a terminal device to User Equipment (UE). The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), a wearable device, Vehicle User Equipment (VUE), or Pedestrian User Equipment (PUE). The wearable device includes a smart watch, a bracelet, a headset, glasses, and the like. It should be noted that a specific type of the terminal 11 is not limited in the embodiments of this application. The network side device 12 may be a base station or a core network device. The base station may be referred to as a NodeB, an evolved NodeB, an access point, a Base Transceiver Station (BTS), a radio base station, a radio transceiver, a Basic Service Set (BSS), an Extended Service Set (ESS), a NodeB, an evolved NodeB (eNB), a home NodeB, a home evolved NodeB, a Wireless Local Area Network (WLAN) access point, a Wireless Fidelity (Wi-Fi) node, a Transmitting Receiving Point (TRP), or another appropriate term in the art. As long as a same technical effect is achieved, the base station is not limited to a specified technical term. It should be noted that, in the embodiments of this application, only a base station in an NR system is used as an example, but a specific type of the base station is not limited.

With reference to the accompanying drawings, an information processing method provided in the embodiments of this application is described in detail by using some embodiments and application scenarios thereof.

Referring to FIG. 2, FIG. 2 is a flowchart of an information processing method according to an embodiment of this application. As shown in FIG. 2, the method includes the following steps:

Step 201: A terminal receives first information sent by a first device entity, where the first information includes at least one of the following:
first sub-information used to indicate the first processing method;
first assistance information used for the first processing method;
result information obtained by performing processing based on a second processing method;
an indication used to request second sub-information, where the second sub-information is terminal-related information or information obtained by performing information feature hiding on the terminal-related information; or
an indication used to request third sub-information, where the third sub-information is used to update a third processing method, where
the first information or an operation performed according to the first information is used to determine at least one of the following: beam or channel measurement, beam or channel measurement reporting, or a beam or channel prediction-related operation.

It should be understood that the first information may include one or more of the first sub-information, the first assistance information, the result information, the indication used to request the second sub-information, and the indication used to request the third sub-information. When the first information includes a plurality of pieces of information, the plurality of pieces of information may be transmitted by using one or more pieces of signaling.

In this embodiment of this application, the first processing method may include a method for processing by using a first neural network, and the first sub-information includes neural network-related information of the first neural network. The terminal-related information may be inferred by using the first processing method, to determine at least one of the following: beam or channel measurement, beam or channel measurement reporting, or a beam or channel prediction-related operation. For example, a beam or channel on which measurement needs to be performed may be determined, and based on the beam or channel on which measurement needs to be performed, at least one of the following is performed: beam or channel measurement, and beam or channel measurement reporting. Further, the terminal-related information and related information of a second entity device may be inferred by using the first processing method, to determine at least one of the following: beam or channel measurement, beam or channel measurement reporting, and a beam or channel prediction-related operation. In this way, the terminal may infer the terminal-related information or the terminal-related information and the related information of the second entity device by using the first processing method, to determine at least one of the following: beam or channel measurement, beam or channel measurement reporting, and a beam or channel prediction-related operation. Therefore, a network side device may adjust a communication state of the terminal based on at least one of a beam or channel measurement result, and a prediction-related operation, to improve air interface performance. An air interface may be understood as an air interface used for communication. It should be noted that in this embodiment of this application, the first information may directly carry content of the first assistance information, or may implicitly indicate the first assistance information by using a network parameter of the first neural network.

In some embodiments, the first entity device and the second entity device may be understood as entity devices on a network side. In some embodiments, the first entity device and the second entity device may be a same entity device, or may be different entity devices. In some embodiments, the first device entity is one or more network elements that collect and distribute information. For example, the first device entity includes one or at least two of the following: a base station, a Location Management Function (LMF), a Network Data Analytics Function (NWDAF), a first network element, and a second network element, where the first network element is a network element configured to perform the second processing method, and the second network element is configured to perform at least one of the following: performing information collection on information required by the second processing method, or performing information calculation on the information required by the second processing method. The second device entity is configured to provide a network service for the terminal. and the second device entity is a base station, a core network device, or another network element other than the base station and the core network device.

It should be understood that the first processing method may be stipulated in advance in a protocol, or may be indicated by the first device entity by using the first sub-information. When the first information includes the first assistance information used for the first processing method, the terminal-related information and the related information of the second entity device may be inferred based on the first processing method indicated by the first sub-information or the first processing method stipulated in the protocol.

The second processing method may be understood as a method in which the first device entity is configured to infer the terminal-related information or the terminal-related information and the related information of the second entity device, to determine at least one of the following: beam or channel measurement, beam or channel measurement reporting, or a beam or channel prediction-related operation. The terminal may report the terminal-related information to the first device entity through exchange in advance, or report the terminal-related information by using the second sub-information, and the first device entity obtains the corresponding result information based on the terminal-related information by using the second processing method, to determine at least one of the following: beam or channel measurement, beam or channel measurement reporting, or a beam or channel prediction-related operation. Therefore, a network side device may adjust a communication state of the terminal based on at least one of a beam or channel measurement result, and a prediction-related operation, to improve air interface performance.

The first processing method and the second processing method may be the same, or may be mutually matched methods. Mutual matching may be understood as: an input of the first processing method may include at least a part of an output of the second processing method, and a corresponding result is obtained by using the first processing method. For example, the output of the second processing method is a plurality of pieces of beam information that need to be measured. The first processing method may further obtain, based on the output of the second processing method, beam information that needs to be reported.

It should be understood that the third processing method may be the first processing method or the second processing method. In some embodiments, the third processing method may be understood as another processing method in another embodiment, for example, a processing method used to perform information feature hiding. When the third processing method is the first processing method, the first device entity may perform corresponding processing according to third sub-information reported by each terminal, for example, update information of the first processing method, and then send the update information to the terminal, so that the terminal updates the first processing method. It is assumed that when the third processing method is the second processing method, the first device entity may update the second processing method according to third information reported by each terminal.

In some embodiments, when the first information includes the indication used to request the third sub-information, the terminal may determine the third sub-information according to a beam measurement result of the terminal and the terminal-related information. In some embodiments, the beam measurement result and the terminal-related information may be used as the third sub-information, or the third processing method may be trained by using the beam measurement result and the terminal-related information, to obtain parameter information used to update the third processing method as the third sub-information. In this way, accuracy of the result information obtained through inference by using the third processing method can be improved.

It should be noted that the first information is used to determine related information, that is, at least one of the following: beam or channel measurement, beam or channel measurement reporting, or a beam or channel prediction-related operation. It may be understood that the related information may be directly or indirectly determined based on the first information. The indirectly determining the related information may be understood as that the first information is used to assist in determining the related information. That the operation performed according to the first information is used to determine the related information may be understood as that the operation performed according to the first information is used to directly or indirectly determine the related information.

In this embodiment of this application, a terminal receives first information sent by a first device entity, where the first information includes at least one of the following: first sub-information used to indicate the first processing method; first assistance information used for the first processing method; result information obtained by performing processing based on a second processing method; an indication used to request second sub-information, where the second sub-information is terminal-related information or information obtained by performing information feature hiding on the terminal-related information, or an indication used to request third sub-information, where the third sub-information is used to update the second processing method, where the first information or an operation performed according to the first information is used to determine at least one of the following: beam or channel measurement, beam or channel measurement reporting, or a beam or channel prediction-related operation. In this way, at least one of the following is determined by using the first information: beam or channel measurement, beam or channel measurement reporting, or a beam or channel prediction-related operation. Therefore, in this embodiment of this application, air interface performance can be improved.

In some embodiments, the first processing method includes a method for processing by using a first neural network, and the first sub-information includes neural network-related information of the first neural network.

In some embodiments, the neural network-related information includes at least one of a structure of the neural network or a parameter of the neural network.

In some embodiments, the first sub-information includes update information for the first processing method.

In this embodiment of this application, the update information of the first processing method may be an updated first processing method, or may be an updated parameter in the first processing method. The first device entity indicates the update information of the first processing method by using the first sub-information, so that the terminal can update the first processing method in time, thereby improving inference accuracy of the first processing method. Therefore, in this embodiment of this application, air interface performance can be further improved.

In some embodiments, the first assistance information meets any one of the following:
the first assistance information is obtained by performing first preset processing on first target information;
the first assistance information is the first target information; or
the first assistance information is the first target information in a case that the terminal performs authentication with the first device entity through a preset interaction authentication procedure, where
the first target information includes related information of a second device entity or information obtained by performing second preset processing on the related information of the second device entity.

In this embodiment of this application, the first device entity and the second device entity may be a same device entity, or may be different device entities. When the first device entity is different from the second device entity, the first device entity may first obtain the first target information. The following provides detailed description based on a case that the first device entity is different from the second device entity.

For example, the first device entity is a core network device, and the second device entity is a base station. The first device entity may send request information to the second device entity, to request the related information of the second device entity The second device entity may directly send the related information of the second device entity to the first device entity, or may send the information to the first device entity after second preset processing is performed on the second device entity. In other words, the first device entity may send the first target information learned from the second device entity to the terminal, and may further process the first target information learned from the second device entity and send the processed information to the terminal.

The second preset processing includes at least one of the following: performing encryption processing or performing feature abstraction processing by using a preset neural network.

It should be understood that a processing manner of the second preset processing may be stipulated in the protocol or indicated by the first device entity. For example, the processing manner of the second preset processing may be indicated in the request information, or the processing manner of the second preset processing may be configured for the second device entity in advance before sending the request.

After receiving the first target information, the first device entity may send the first target information to the terminal as the first assistance information. In some embodiments, in a case that the terminal performs authentication with the first device entity through a preset interaction procedure, the first target information may be sent to the terminal as the first assistance information. After the first preset processing is performed on the first target information, the first assistance information may be obtained, and then the first assistance information is sent to the terminal.

The processing manner of the first preset processing may be stipulated in the protocol, indicated by the terminal, or determined by the first device entity. This is not further limited herein. In some embodiments of this application, the first preset processing includes at least one of the following: performing encryption processing or performing feature abstraction processing by using a preset neural network.

In some embodiments, the related information of the second device entity includes at least one of measurement information of the second device entity, implementation information of the second device entity, or statistics information of the second device entity.

In this embodiment of this application, the implementation information of the second device entity includes at least one of antenna configuration information of the second device entity, beam direction information of the second device entity, or location coordinate information of the second device entity; or
the measurement information of the second device entity includes measurement information obtained by the second device entity on an air interface; or
the statistics information of the second device entity includes statistics information obtained by performing long-term measurement on an air interface by the second device entity.

In some embodiments, the related information of the second device entity includes at least one of the following: information about the terminal on a corresponding carrier or bandwidth part; statistics information of one terminal on a plurality of carriers or bandwidth parts; or statistics information of a plurality of terminals.

In some embodiments, an input of the first processing method includes at least one of the following: terminal antenna information, terminal location information, or a beam feature for measuring beam quality. The beam feature may be a directivity pattern.

The terminal location information is highly correlated with a Channel State Information (CSI) result, a beam measurement result, and a Radio resource management (RRM) measurement result, and can effectively assist in CSI prediction, motion track prediction, and the like.

An output of the first processing method is information about beam quality in a plurality of directions. Information about the beam quality includes a beam identifier, a beam direction, and beam signal strength.

In this embodiment of this application, an example in which the first processing method is the method for processing by using the first neural network is used for description. The first neural network can use at least one of terminal-specific implementation, terminal location information, or a beam feature for measuring beam quality as an input, and use beam quality as an output. The beam quality may provide prediction of beam signal quality in each direction based on a beam directivity pattern, and may include a beam identifier, a beam direction, and beam signal strength. The terminal may describe possible beam information through this output, and provide a required receive beam with reference to different beam directivity patterns. A beam measurement result may be reported to the first device entity or the second device entity based on a result output by the first processing method.

In some embodiments, before the receiving, by a terminal, first information sent by a first device entity, the method further includes:
sending, by the terminal, a first request to the first device entity, where the first request is used to obtain the first information.

In this embodiment of this application, the terminal may actively request to obtain the first information. In another embodiment, the first device entity may periodically send the first information or the first device entity may be triggered to send the first information based on a preset condition.

In some embodiments, the first request carries second assistance information associated with the information feature hiding, and the second assistance information is used to determine the second sub-information.

In some embodiments, the second assistance information includes a public key for encryption.

In this embodiment of this application, the first information includes the indication used to request the second sub-information, and the second sub-information is the information obtained by performing information feature hiding on the terminal-related information. After obtaining the second assistance information, the first device entity may send the second assistance information to the second device entity. In another embodiment, the terminal may further directly send the second assistance information to the second device entity. The second device entity may perform a corresponding processing operation based on the second assistance information. For example, after performing the second preset processing (for example, encryption processing) on the related information of the second device entity, the second device entity sends the processed first target information to the first device entity.

In a case that the first information is the indication used to request the second sub-information, after the receiving, by a terminal, first information sent by a first device entity, the method further includes:
sending, by the terminal, the second sub-information to the first device entity.

In this embodiment of this application, the first device entity may perform, by using the second processing method, corresponding processing on the second sub-information to obtain a processing result, or may aggregate the second sub-information with the obtained first target information, and then feed back information obtained after the aggregation to the terminal. Then, the terminal performs corresponding processing by using the first processing method.

In some embodiments, the terminal-related information includes at least one of the following: antenna-related information or location information of the terminal.

In some embodiments, the antenna-related information includes at least one of the following: a panel quantity, a beam quantity, a beam identifier, or a directivity pattern of each beam.

In some embodiments, the second sub-information includes information obtained by aggregating related information of a second device entity with the terminal-related information.

In this embodiment, the terminal may obtain the related information of the second device entity in advance. In this case, the related information of the second device entity may be information on which information feature hiding is not performed, or may be information on which information feature hiding is performed. This is not further limited herein. In a case that the terminal receives the indication used to request the second sub-information, the terminal may aggregate the related information of the second device entity with the terminal-related information to obtain the second sub-information, and then send the second sub-information to the first device entity, so that the first device entity performs corresponding processing, for example, performs inference by using the second processing method.

In a case that the first information is the result information obtained by performing processing based on the second processing method, before the receiving, by a terminal, first information sent by a first device entity, the method further includes:
sending, by the terminal to the first device entity, a beam measurement result and the information obtained by performing information feature hiding on the terminal-related information, where the beam measurement result and the information obtained by performing information feature hiding on the terminal-related information are used to determine the result information.

In this embodiment of this application, the terminal may first send the beam measurement result and the information obtained by performing information feature hiding on the terminal-related information to the first device entity, and the first device entity performs inference by using corresponding information based on the second processing method to obtain result information, and sends a result to the terminal, so that the terminal performs further processing based on the result information, and then sends a final result to the first device entity or the second device entity. For example, the result information may be a plurality of pieces of beam information that need to be measured, and the terminal may further perform measurement based on the plurality of pieces of beam information that need to be measured, to obtain a corresponding result, and finally report the beam measurement result. In some embodiments, the result information may be prediction information of each beam, and the terminal performs further processing based on the prediction information of each beam to determine the beam information that needs to be reported. In some embodiments, behavior of the terminal based on the result information includes but is not limited to the foregoing cases. Details are not described herein again.

In a case that the third processing method includes a method for processing by using a third neural network and the first information is the indication used to request the third sub-information, after the receiving, by a terminal, first information sent by a first device entity, the method further includes:
sending, by the terminal, the third sub-information to the first device entity, where the third sub-information is network parameter update information of the third neural network.

In this embodiment of this application, when the third processing method is the first processing method, the third neural network may be understood as the first neural network. In this case, the first device entity may perform corresponding processing according to third sub-information reported by each terminal to obtain network parameter update information, and send the network parameter update information to the terminal for updating. In this case, the network parameter update information may be carried in the first sub-information.

When the third processing method is the second processing method, the third neural network may be understood as a second neural network associated with the second processing method, and the first device entity may update the second neural network according to third information reported by each terminal.

In some embodiments, the network parameter update information is obtained by training the third neural network based on a plurality of beam measurement results and terminal implementation.

In this embodiment of this application, the terminal may train a neural network based on a plurality groups of local measurement results and terminal implementation, to update a neural network of the terminal or the first device entity.

It should be noted that terminal implementation information also greatly affects possible beam measurement. For example, available beam information of the terminal greatly affects a quantity of required Reference Signal (RS) measurement resources. In addition, the terminal implementation information also greatly affects service prediction. For example, when power is low, the terminal may reduce data consumption. A terminal with a relatively low processing capability may not use a specific application, and a terminal of another type may be more likely to trigger a specific type of service. For example, a user of a game mobile phone may trigger a specific type of game service in a specific time period and at a specific location. The terminal implementation information is rarely exposed to the network side, and this type of service prediction cannot be effectively assisted.

To better understand this application, the following is described in detail by using some specific examples by assuming that the first device entity is different from the second device, and the second device entity is a base station.

Embodiment 1: Including the Following Procedures:

Step 1: A terminal requests neural network assistance information of a corresponding neural network from a first device entity, where the neural network assistance information may be understood as the foregoing second sub-information.

The neural network may be abstract enough. In such a specific application, it may be difficult for the terminal to learn corresponding network implementation from the corresponding assistance information; or enough trust is established between the network and the terminal through a specific interaction authentication procedure, to ensure that such exposure does not pose a threat to the network.

In some embodiments, before the foregoing step 1, or triggered by the foregoing step 1, the first device entity requests corresponding data (that is, related information of a second device entity) from a base station.

In some embodiments, when or before requesting the corresponding data from the base station, the first device entity sends a corresponding computing network to the base station, and the base station sends, to the first device entity, the corresponding data or data obtained by using the corresponding computing network from the corresponding data.

Step 2: The first device entity delivers the corresponding neural network assistance information.

In some embodiments, the neural network assistance information includes data obtained from the base station or further processed data obtained from the base station.

In some embodiments, the neural network assistance information includes a specific neural network. Such a neural network can use terminal specific implementation as an input, and/or terminal location information as an input, and/or a beam feature (for example, a directivity pattern) used by the terminal to measure beam quality as an input, and use beam quality as an output.

Further, for the beam quality as the output, signal quality of a beam in each direction may be predicted without considering a beam directivity pattern, including an identifier of a corresponding beam, a direction of a corresponding beam, and strength of a corresponding beam signal. The terminal describes all possible beam information in this output, and provides a required receive beam with reference to different beam directivity patterns.

Step 3: The terminal performs corresponding inference based on the neural network assistance information sent by the first device entity.

Step 4: The terminal reports a corresponding beam measurement result to the base station based on an inference result.

Embodiment 2: Including the Following Procedures:

A terminal initiates a corresponding request to a first device entity.

The terminal performs information feature hiding on corresponding information and then sends the information to the first device entity. In some embodiments, the information feature hiding includes information encryption, and the information includes a possible implementation: a panel quantity, a beam quantity, an identifier corresponding to each beam, a directivity pattern corresponding to each beam, and the like. In some embodiments, the information may further include location information. In some embodiments, required information needs to be pre-configured or stipulated.

The terminal communicates information feature hiding assistance information with the first device entity, for example, notifies the first device of public key information.

The first device entity initiates a corresponding data request to a base station, and communicates, with the base station, the information feature hiding assistance information that is used for related processing, or the terminal directly communicates the information feature hiding assistance information with the base station.

After performing information feature hiding on the information by using the learned assistance information for corresponding processing, the base station sends the information to the first entity. In a predefined condition (for example, a condition for performing authentication or authorization), information feature hiding is not performed, and related information is directly sent to the first device entity. The information implies specific network implementation, such as an antenna configuration on a network side and a base station location. This information can also imply measurement of a surrounding wireless environment by the base station.

The first device entity aggregates, based on a specific network, learned information sent by the terminal and the base station, and sends aggregated information to the terminal; and the first device entity simultaneously notifies the terminal how to use notified information. In some embodiments, an aggregated feature is that data information before aggregation cannot be learned from the aggregated information. A use manner includes a corresponding neural network, and how to use with other information. For example, the aggregated information is used as a part of the neural network for input. The aggregated information may not be an explicit independent feature, and may be implied by using a neural network parameter. That is, the first device entity distributes only one neural network to the terminal. The neural network directly uses a measurement result and other information on the terminal side as an input, and does not use the aggregated information as an input. The aggregated information is implied in the neural network parameter.

The terminal decrypts the aggregated information, but the terminal does not know an aggregation manner, and cannot obtain valuable information of the base station.

The terminal predicts beam measurement by using the decrypted aggregation information and the corresponding neural network. There are a plurality of possible implementations of the neural network.

The terminal provides a corresponding beam report to the base station according to a predefined rule.

Embodiment 3: This is totally performed by a first device entity. A terminal needs to encrypt a measurement result and other implementation information, and then send the encrypted information to the first device entity. The first device entity performs an operation based on the encrypted data, and then feeds back the data to the terminal. After decrypting a result, the terminal further uses the result.

For the foregoing Embodiment 1 to Embodiment 3, further, the neural network may be updated. In some embodiments, the following procedures are included:

The terminal requests a current neural network from the first device entity, and the neural network may already include implementation of the base station.

The first device entity distributes a corresponding neural network to the terminal. In some embodiments, the first device entity updates the neural network by continuously collecting data. The neural network uses terminal implementation as an input, and may further use a measurement result as an input.

The terminal updates the neural network according to a plurality of groups of local measurement results and the terminal implementation, where the local measurement results include measurement results of a plurality of beams.

Referring to FIG. 3, FIG. 3 is a flowchart of another information processing method according to an embodiment of this application. As shown in FIG. 3, the method includes the following steps:

Step 301: A first device entity sends first information to a terminal, where the first information includes at least one of the following:
first sub-information used to indicate the first processing method;
first assistance information used for the first processing method;
result information obtained by performing processing based on a second processing method;
an indication used to request second sub-information, where the second sub-information is terminal-related information or information obtained by performing information feature hiding on the terminal-related information; or
an indication used to request third sub-information, where the third sub-information is used to update a third processing method, where
the first information or an operation performed according to the first information is used to determine at least one of the following: beam or channel measurement, beam or channel measurement reporting, or a beam or channel prediction-related operation.

In some embodiments, the first processing method includes a method for processing by using a first neural network, and the first sub-information includes neural network-related information of the first neural network.

In some embodiments, the neural network-related information includes at least one of a structure of the neural network or a parameter of the neural network.

In some embodiments, the first sub-information includes update information for the first processing method.

In some embodiments, the first device entity includes one or at least two of the following: a base station, a local management function LMF, a network data analytics function NWDAF, a first network element, and a second network element, where the first network element is a network element configured to perform the second processing method, and the second network element is configured to perform at least one of the following: performing information collection on information required by the second processing method, or performing information calculation on the information required by the second processing method.

In some embodiments, the first assistance information meets any one of the following:
the first assistance information is obtained by performing first preset processing on first target information;
the first assistance information is the first target information; or
the first assistance information is the first target information in a case that the terminal performs authentication with the first device entity through a preset interaction authentication procedure, where
the first target information includes related information of a second device entity or information obtained by performing second preset processing on the related information of the second device entity.

In some embodiments, the related information of the second device entity includes at least one of measurement information of the second device entity, implementation information of the second device entity, or statistics information of the second device entity.

In some embodiments, the implementation information of the second device entity includes at least one of antenna configuration information of the second device entity, beam direction information of the second device entity, or location coordinate information of the second device entity; or
the measurement information of the second device entity includes measurement information obtained by the second device entity on an air interface; or
the statistics information of the second device entity includes statistics information obtained by performing long-term measurement on an air interface by the second device entity.

In some embodiments, the related information of the second device entity includes at least one of the following: information about the terminal on a corresponding carrier or bandwidth part; statistics information of one terminal on a plurality of carriers or bandwidth parts; or statistics information of a plurality of terminals.

In some embodiments, the first preset processing includes at least one of the following: performing encryption processing or performing feature abstraction processing by using a preset neural network.

In some embodiments, the second preset processing includes at least one of the following: performing encryption processing or performing feature abstraction processing by using a preset neural network.

In some embodiments, an input of the first processing method includes at least one of the following: terminal antenna information, terminal location information, or a beam feature for measuring beam quality.

In some embodiments, an output of the first processing method is information about beam quality in a plurality of directions.

Information about the beam quality includes a beam identifier, a beam direction, and beam signal strength.

In some embodiments, the second device entity is configured to provide a network service for the terminal, and the second device entity is a base station, a core network device, or another network element other than the base station and the core network device.

In some embodiments, before the sending, by a first device entity, first information to a terminal, the method further includes:
receiving, by the first device entity, a first request sent by the terminal, where the first request is used to obtain the first information.

In some embodiments, the first request carries second assistance information associated with the information feature hiding, and the second assistance information is used to determine the second sub-information.

In some embodiments, the second assistance information includes a public key for encryption.

In some embodiments, after the sending, by a first device entity, first information to a terminal, the method further includes:
receiving, by the first device entity, the second sub-information sent by the terminal.

In some embodiments, the terminal-related information includes at least one of the following: antenna-related information or location information of the terminal.

In some embodiments, the antenna-related information includes at least one of the following: a panel quantity, a beam quantity, a beam identifier, or a directivity pattern of each beam.

In some embodiments, the second sub-information includes information obtained by aggregating related information of a second device entity with the terminal-related information.

In a case that the first information is the result information obtained by performing processing based on the second processing method, before the sending, by a first device entity, first information to a terminal, the method further includes:
receiving, by the first device entity, a beam measurement result and the information obtained by performing information feature hiding on the terminal-related information that are sent by the terminal, where the beam measurement result and the information obtained by performing information feature hiding on the terminal-related information are used to determine the result information.

In some embodiments, when the first device entity is different from the second device entity, before the sending, by a first device entity, first information to a terminal, the method further includes:
sending, by the first device entity, a second request to the second device entity, where the second request is used to obtain the related information of the second device entity: and
receiving, by the first device entity, the related information of the second device entity sent by the second device entity.

In a case that the first sub-information of the first processing method includes neural network-related information of a first neural network and the first assistance information is obtained after first preset processing is performed on the first target information, the first assistance information is implied in a network parameter of the first neural network. In other words, the network parameter of the first neural network implicitly indicates the first assistance information.

In a case that the first information includes the first assistance information, the method further includes:
sending, by the first device entity, first indication information to the second device entity, where the first indication information is used to indicate the second preset processing.

In a case that the third processing method includes a method for processing by using a third neural network and the first information is the indication used to request the third sub-information, after the sending, by a first device entity, first information to a terminal, the method further includes:
receiving, by the first device entity, the third sub-information sent by the terminal, where the third sub-information is network parameter update information of the third neural network.

In the case that the third processing method is a method for processing by using a third neural network, the method further includes:
performing, by the first device entity, training update on the third neural network according to third sub-information sent by each terminal, where
the third sub-information is determined by each terminal according to a beam measurement result and the terminal-related information.

It should be noted that this embodiment is used as an implementation of the first device entity corresponding to the embodiment shown in FIG. 2. For a specific implementation of this embodiment, refer to the related descriptions of the embodiment shown in FIG. 2. To avoid repeated descriptions, details are not described again herein.

Referring to FIG. 4, FIG. 4 is a flowchart of another information processing method according to an embodiment of this application. As shown in FIG. 4, the method includes the following steps:

Step 401: A second device entity sends first target information to a first device entity, where the first target information includes related information of the second device entity or information obtained by performing second preset processing on the related information of the second device entity, and the first target information is used to determine first information sent by the first device entity to a terminal.

The first information includes at least one of the following:
first sub-information used to indicate the first processing method;
first assistance information used for the first processing method; or
result information obtained by performing processing based on a second processing method, where
the first information or an operation performed according to the first information is used to determine at least one of the following: beam or channel measurement, beam or channel measurement reporting, or a beam or channel prediction-related operation.

In some embodiments, the first processing method includes a method for processing by using a first neural network, and the first sub-information includes neural network-related information of the first neural network.

In some embodiments, the neural network-related information includes at least one of a structure of the neural network or a parameter of the neural network.

In some embodiments, the first sub-information includes update information for the first processing method.

In some embodiments, the first device entity includes one or at least two of the following: a base station, a local management function LMF, a network data analytics function NWDAF, a first network element, and a second network element, where the first network element is a network element configured to perform the second processing method, and the second network element is configured to perform at least one of the following: performing information collection on information required by the second processing method, or performing information calculation on the information required by the second processing method.

In some embodiments, the first assistance information meets any one of the following:
the first assistance information is obtained by performing first preset processing on first target information;
the first assistance information is the first target information; or
the first assistance information is the first target information in a case that the terminal performs authentication with the first device entity through a preset interaction authentication procedure, where
the first target information includes related information of a second device entity or information obtained by performing second preset processing on the related information of the second device entity.

In some embodiments, the related information of the second device entity includes at least one of measurement information of the second device entity, implementation information of the second device entity, or statistics information of the second device entity.

In some embodiments, the implementation information of the second device entity includes at least one of antenna configuration information of the second device entity, beam direction information of the second device entity, or location coordinate information of the second device entity; or
the measurement information of the second device entity includes measurement information obtained by the second device entity on an air interface; or
the statistics information of the second device entity includes statistics information obtained by performing long-term measurement on an air interface by the second device entity.

In some embodiments, the related information of the second device entity includes at least one of the following: information about the terminal on a corresponding carrier or bandwidth part; statistics information of one terminal on a plurality of carriers or bandwidth parts; or statistics information of a plurality of terminals.

In some embodiments, the first preset processing includes at least one of the following, performing encryption processing or performing feature abstraction processing by using a preset neural network.

In some embodiments, the second preset processing includes at least one of the following: performing encryption processing or performing feature abstraction processing by using a preset neural network.

In some embodiments, an input of the first processing method includes at least one of the following: terminal antenna information, terminal location information, or a beam feature for measuring beam quality.

In some embodiments, an output of the first processing method is information about beam quality in a plurality of directions.

Information about the beam quality includes a beam identifier, a beam direction, and beam signal strength.

In some embodiments, the second device entity is configured to provide a network service for the terminal, and the second device entity is a base station, a core network device, or another network element other than the base station and the core network device.

In some embodiments, the terminal-related information includes at least one of the following: antenna-related information or location information of the terminal.

In some embodiments, the antenna-related information includes at least one of the following: a panel quantity, a beam quantity, a beam identifier, or a directivity pattern of each beam.

In some embodiments, the second sub-information includes information obtained by aggregating related information of a second device entity with the terminal-related information.

In some embodiments, before the sending, by a second device entity, related information of the second device entity to a first device entity, the method further includes:
receiving, by the second device entity, a second request sent by the first device entity, where the second request is used to obtain the related information of the second device entity.

In some embodiments, before the sending, by a second device entity, first target information to a first device entity, the method further includes:
receiving, by the second device entity, second assistance information sent by the terminal or the first device entity, where the second assistance information is associated with performing information feature hiding on terminal-related information by the terminal, and the second assistance information is used to determine the second preset processing method.

It should be noted that this embodiment is used as an implementation of the second device entity corresponding to the embodiment shown in FIG. 2. For a specific implementation of this embodiment, refer to the related descriptions of the embodiment shown in FIG. 2. To avoid repeated descriptions, details are not described again herein.

Referring to FIG. 5. FIG. 5 is a flowchart of another information processing method according to an embodiment of this application. As shown in FIG. 5, the method includes the following steps:

Step 501: A first device entity sends first information to a terminal.

Step 502: The terminal receives the first information, where the first information includes at least one of the following:
first sub-information used to indicate the first processing method;
first assistance information used for the first processing method;
result information obtained by performing processing based on a second processing method;
an indication used to request second sub-information, where the second sub-information is terminal-related information or information obtained by performing information feature hiding on the terminal-related information; or
an indication used to request third sub-information, where the third sub-information is used to update a third processing method, where
the first information or an operation performed according to the first information is used to determine at least one of the following: beam or channel measurement, beam or channel measurement reporting, or a beam or channel prediction-related operation.

In some embodiments, the method further includes:
sending, by the terminal, second assistance information associated with the information feature hiding to the first device entity;
sending, by the first device entity, the second assistance information to a second device entity;
determining, by the second device entity, a second preset processing method according to the second assistance information;
obtaining, by the second device entity, first target information after processing related information of the second device entity by using the second preset processing method; and
sending, by the second device entity, the first target information to the first device entity.

In some embodiments, the method further includes:
sending, by the terminal, the second assistance information associated with the information feature hiding to the second device entity; and
determining, by the second device entity, a second preset processing method according to the second assistance information;
obtaining, by the second device entity, first target information after processing related information of the second device entity by using the second preset processing method; and
sending, by the second device entity, the first target information to the first device entity.

In some embodiments, the second assistance information includes a public key for encryption.

In some embodiments, the first processing method includes a method for processing by using a first neural network, and the first sub-information includes neural network-related information of the first neural network.

In some embodiments, the neural network-related information includes at least one of a structure of the neural network or a parameter of the neural network.

In some embodiments, the first sub-information includes update information for the first processing method.

In some embodiments, the first device entity includes one or at least two of the following: a base station, a local management function LMF, a network data analytics function NWDAF, a first network element, and a second network element, where the first network element is a network element configured to perform the second processing method, and the second network element is configured to perform at least one of the following: performing information collection on information required by the second processing method, or performing information calculation on the information required by the second processing method.

In some embodiments, the first assistance information meets any one of the following:
the first assistance information is obtained by performing first preset processing on first target information;
the first assistance information is the first target information; or
the first assistance information is the first target information in a case that the terminal performs authentication with the first device entity through a preset interaction authentication procedure, where
the first target information includes related information of a second device entity or information obtained by performing second preset processing on the related information of the second device entity.

In some embodiments, the related information of the second device entity includes at least one of measurement information of the second device entity, implementation information of the second device entity, or statistics information of the second device entity.

In some embodiments, the implementation information of the second device entity includes at least one of antenna configuration information of the second device entity, beam direction information of the second device entity, or location coordinate information of the second device entity; or
the measurement information of the second device entity includes measurement information obtained by the second device entity on an air interface; or
the statistics information of the second device entity includes statistics information obtained by performing long-term measurement on an air interface by the second device entity.

In some embodiments, the related information of the second device entity includes at least one of the following: information about the terminal on a corresponding carrier or bandwidth part; statistics information of one terminal on a plurality of carriers or bandwidth parts; or statistics information of a plurality of terminals.

In some embodiments, the first preset processing includes at least one of the following: performing encryption processing or performing feature abstraction processing by using a preset neural network.

In some embodiments, the second preset processing includes at least one of the following: performing encryption processing or performing feature abstraction processing by using a preset neural network.

In some embodiments, an input of the first processing method includes at least one of the following: terminal antenna information, terminal location information, or a beam feature for measuring beam quality.

In some embodiments, an output of the first processing method is information about beam quality in a plurality of directions.

Information about the beam quality includes a beam identifier, a beam direction, and beam signal strength.

In some embodiments, the second device entity is configured to provide a network service for the terminal, and the second device entity is a base station, a core network device, or another network element other than the base station and the core network device.

In a case that the first information is the indication used to request the second sub-information, after the receiving, by a terminal, first information sent by a first device entity, the method further includes:
sending, by the terminal, the second sub-information to the first device entity.

In some embodiments, the terminal-related information includes at least one of the following: antenna-related information or location information of the terminal.

In some embodiments, the antenna-related information includes at least one of the following: a panel quantity, a beam quantity, a beam identifier, or a directivity pattern of each beam.

In some embodiments, the second sub-information includes information obtained by aggregating related information of a second device entity with the terminal-related information.

It should be noted that this embodiment is used as an implementation of the second device entity corresponding to the embodiment shown in FIG. 2. For a specific implementation of this embodiment, refer to the related descriptions of the embodiment shown in FIG. 2. To avoid repeated descriptions, details are not described again herein.

It should be noted that the information processing method provided in the embodiments of this application may be performed by an information processing apparatus, or a control module that is in the information processing apparatus and that is configured to perform the information processing method. In the embodiments of this application, that the information processing apparatus performs the information processing method is used as an example to describe the information processing apparatus provided in the embodiments of this application.

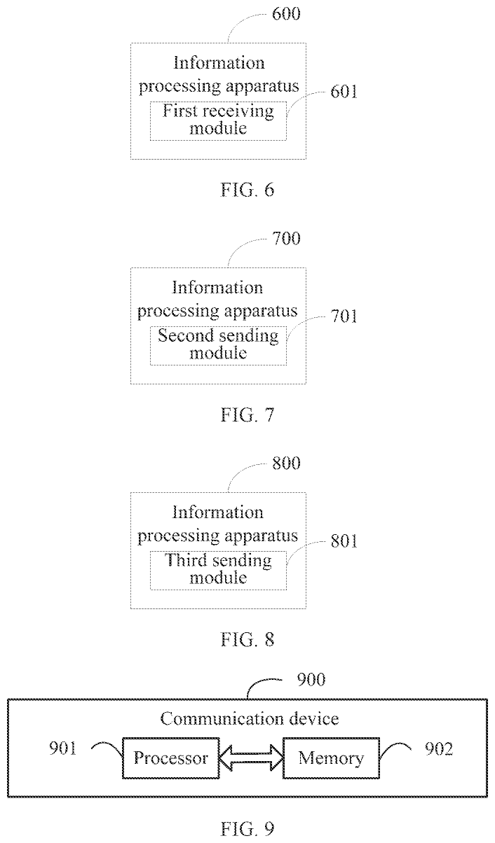

Referring to FIG. 6, FIG. 6 is a structural diagram of an information processing apparatus according to an embodiment of this application. As shown in FIG. 6, an information processing apparatus 600 includes:
a first receiving module 601, configured to receive first information sent by a first device entity, where the first information includes at least one of the following:
first sub-information used to indicate the first processing method;
first assistance information used for the first processing method;
result information obtained by performing processing based on a second processing method;
an indication used to request second sub-information, where the second sub-information is terminal-related information or information obtained by performing information feature hiding on the terminal-related information; or
an indication used to request third sub-information, where the third sub-information is used to update a third processing method, where
the first information or an operation performed according to the first information is used to determine at least one of the following: beam or channel measurement, beam or channel measurement reporting, or a beam or channel prediction-related operation.

In some embodiments, the first processing method includes a method for processing by using a first neural network, and the first sub-information includes neural network-related information of the first neural network.

In some embodiments, the neural network-related information includes at least one of a structure of the neural network or a parameter of the neural network.

In some embodiments, the first sub-information includes update information for the first processing method.

In some embodiments, the first device entity includes one or at least two of the following: a base station, a local management function LMF, a network data analytics function NWDAF, a first network element, and a second network element, where the first network element is a network element configured to perform the second processing method, and the second network element is configured to perform at least one of the following: performing information collection on information required by the second processing method, or performing information calculation on the information required by the second processing method.

In some embodiments, the first assistance information meets any one of the following:
the first assistance information is obtained by performing first preset processing on first target information;
the first assistance information is the first target information; or
the first assistance information is the first target information in a case that the terminal performs authentication with the first device entity through a preset interaction authentication procedure, where
the first target information includes related information of a second device entity or information obtained by performing second preset processing on the related information of the second device entity.

In some embodiments, the related information of the second device entity includes at least one of measurement information of the second device entity, implementation information of the second device entity, or statistics information of the second device entity.

In some embodiments, the implementation information of the second device entity includes at least one of antenna configuration information of the second device entity, beam direction information of the second device entity, or location coordinate information of the second device entity; or
the measurement information of the second device entity includes measurement information obtained by the second device entity on an air interface; or
the statistics information of the second device entity includes statistics information obtained by performing long-term measurement on an air interface by the second device entity.

In some embodiments, the related information of the second device entity includes at least one of the following: information about the terminal on a corresponding carrier or bandwidth part; statistics information of one terminal on a plurality of carriers or bandwidth parts; or statistics information of a plurality of terminals.

In some embodiments, the first preset processing includes at least one of the following: performing encryption processing or performing feature abstraction processing by using a preset neural network.

In some embodiments, the second preset processing includes at least one of the following: performing encryption processing or performing feature abstraction processing by using a preset neural network.

In some embodiments, an input of the first processing method includes at least one of the following: terminal antenna information, terminal location information, or a beam feature for measuring beam quality.

In some embodiments, an output of the first processing method is information about beam quality in a plurality of directions.

Information about the beam quality includes a beam identifier, a beam direction, and beam signal strength.

In some embodiments, the second device entity is configured to provide a network service for the terminal, and the second device entity is a base station, a core network device, or another network element other than the base station and the core network device.

In some embodiments, the information processing apparatus further includes:
a first sending module, configured to send a first request to the first device entity, where the first request is used to obtain the first information.

In some embodiments, the first request carries second assistance information associated with the information feature hiding, and the second assistance information is used to determine the second sub-information.

In some embodiments, the second assistance information includes a public key for encryption.

In a case that the first information is the indication used to request the second sub-information, the information processing apparatus further includes:
a first sending module, configured to send the second sub-information to the first device entity.

In some embodiments, the terminal-related information includes at least one of the following: antenna-related information or location information of the terminal.

In some embodiments, the antenna-related information includes at least one of the following: a panel quantity, a beam quantity, a beam identifier, or a directivity pattern of each beam.

In some embodiments, the second sub-information includes information obtained by aggregating related information of a second device entity with the terminal-related information.

In a case that the first information is the result information obtained by performing processing based on the second processing method, the information processing apparatus further includes:
a first sending module, configured to send, to the first device entity, a beam measurement result and the information obtained by performing information feature hiding on the terminal-related information, where the beam measurement result and the information obtained by performing information feature hiding on the terminal-related information are used to determine the result information.

In a case that the third processing method includes a method for processing by using a third neural network and the first information is the indication used to request the third sub-information, the information processing apparatus further includes:
a first sending module, configured to send the third sub-information to the first device entity, where the third sub-information is network parameter update information of the third neural network.

In some embodiments, the network parameter update information is obtained by training the third neural network based on a plurality of beam measurement results and terminal implementation.

The information processing apparatus provided in this embodiment of this application can implement the processes in the method embodiment in FIG. 2. To avoid repetition, details are not described herein again.

Referring to FIG. 7, FIG. 7 is a structural diagram of an information processing apparatus according to an embodiment of this application. As shown in FIG. 7, an information processing apparatus 700 includes:
a second sending module 701, configured to perform first information to a terminal, where the first information includes at least one of the following:
first sub-information used to indicate the first processing method;
first assistance information used for the first processing method;
result information obtained by performing processing based on a second processing method;
an indication used to request second sub-information, where the second sub-information is terminal-related information or information obtained by performing information feature hiding on the terminal-related information; and
an indication used to request third sub-information, where the third sub-information is used to update a third processing method, where
the first information or an operation performed according to the first information is used to determine at least one of the following: beam or channel measurement, beam or channel measurement reporting, and a beam or channel prediction-related operation.

In some embodiments, the first processing method includes a method for processing by using a first neural network, and the first sub-information includes neural network-related information of the first neural network.

In some embodiments, the neural network-related information includes at least one of a structure of the neural network and a parameter of the neural network.

In some embodiments, the first sub-information includes update information for the first processing method.

In some embodiments, the first device entity includes one or at least two of the following: a base station, a local management function LMF, a network data analytics function NWDAF, a first network element, and a second network element, where the first network element is a network element configured to perform the second processing method, and the second network element is configured to perform at least one of the following: performing information collection on information required by the second processing method, and performing information calculation on the information required by the second processing method.

In some embodiments, the first assistance information meets any one of the following:
the first assistance information is obtained by performing first preset processing on first target information;
the first assistance information is the first target information; and
the first assistance information is the first target information in a case that the terminal performs authentication with the first device entity through a preset interaction authentication procedure, where
the first target information includes related information of a second device entity or information obtained by performing second preset processing on the related information of the second device entity.

In some embodiments, the related information of the second device entity includes at least one of measurement information of the second device entity, implementation information of the second device entity, and statistics information of the second device entity.

In some embodiments, the implementation information of the second device entity includes at least one of antenna configuration information of the second device entity, beam direction information of the second device entity, and location coordinate information of the second device entity; or
the measurement information of the second device entity includes measurement information obtained by the second device entity on an air interface; or
the statistics information of the second device entity includes statistics information obtained by performing long-term measurement on an air interface by the second device entity.

In some embodiments, the related information of the second device entity includes at least one of the following: information about the terminal on a corresponding carrier or bandwidth part; statistics information of one terminal on a plurality of carriers or bandwidth parts; and statistics information of a plurality of terminals.

In some embodiments, the first preset processing includes at least one of the following: performing encryption processing and performing feature abstraction processing by using a preset neural network.

In some embodiments, the second preset processing includes at least one of the following, performing encryption processing and performing feature abstraction processing by using a preset neural network.

In some embodiments, an input of the first processing method includes at least one of the following: terminal antenna information, terminal location information, and a beam feature for measuring beam quality.

In some embodiments, an output of the first processing method is information about beam quality in a plurality of directions.

Information about the beam quality includes a beam identifier, a beam direction, and beam signal strength.

In some embodiments, the second device entity is configured to provide a network service for the terminal, and the second device entity is a base station, a core network device, or another network element other than the base station and the core network device.

In some embodiments, the information processing apparatus 700 further includes:
a second receiving module, configured to receive a first request sent by the terminal, where the first request is used to obtain the first information.

In some embodiments, the first request carries second assistance information associated with the information feature hiding, and the second assistance information is used to determine the second sub-information.

In some embodiments, the second assistance information includes a public key for encryption.

In some embodiments, the information processing apparatus 700 further includes:
a second receiving module, configured to receive the second sub-information sent by the terminal.

In some embodiments, the terminal-related information includes at least one of the following: antenna-related information and location information of the terminal.

In some embodiments, the antenna-related information includes at least one of the following: a panel quantity, a beam quantity, a beam identifier, and a directivity pattern of each beam.

In some embodiments, the second sub-information includes information obtained by aggregating related information of a second device entity with the terminal-related information.

In a case that the first information is the result information obtained by performing processing based on the second processing method, the information processing apparatus 700 further includes:
a second receiving module, configured to receive a beam measurement result and the information obtained by performing information feature hiding on the terminal-related information that are sent by the terminal, where the beam measurement result and the information obtained by performing information feature hiding on the terminal-related information are used to determine the result information.

In some embodiments, when the first device entity is different from the second device entity, the information processing apparatus 700 further includes a second receiving module:
the second sending module 701 is further configured to send a second request to the second device entity, where the second request is used to obtain the related information of the second device entity; and
the second receiving module is configured to receive the related information of the second device entity sent by the second device entity.

In a case that the first sub-information of the first processing method includes neural network-related information of a first neural network and the first assistance information is obtained after first preset processing is performed on the first target information, the first assistance information is implied in a network parameter of the first neural network.

In a case that the first information includes the first assistance information, the second sending module 701 is further configured to send first indication information to the second device entity, where the first indication information is used to indicate the second preset processing.

In a case that the third processing method includes a method for processing by using a third neural network and the first information is the indication used to request the third sub-information, the information processing apparatus 700 further includes: a second receiving module, configured to receive the third sub-information sent by the terminal, where the third sub-information is network parameter update information of the third neural network.

In the case that the third processing method is a method for processing by using a third neural network, the second sending module 701 is further configured to perform, training update on the third neural network according to third sub-information sent by each terminal, where
the third sub-information is determined by each terminal according to a beam measurement result and the terminal-related information.

The information processing apparatus provided in this embodiment of this application can implement the processes in the method embodiment in FIG. 3. To avoid repetition, details are not described herein again.

Referring to FIG. 8, FIG. 8 is a structural diagram of an information processing apparatus according to an embodiment of this application. As shown in FIG. 8, an information processing apparatus 800 includes:
a third sending module 801, configured to send first target information to a first device entity, where the first target information includes related information of the second device entity or information obtained by performing second preset processing on the related information of the second device entity, and the first target information is used to determine first information sent by the first device entity to a terminal, where
the first information includes at least one of the following:
first sub-information used to indicate the first processing method;
first assistance information used for the first processing method; and
result information obtained by performing processing based on a second processing method, where
the first information or an operation performed according to the first information is used to determine at least one of the following: beam or channel measurement, beam or channel measurement reporting, and a beam or channel prediction-related operation.

In some embodiments, the first processing method includes a method for processing by using a first neural network, and the first sub-information includes neural network-related information of the first neural network.

In some embodiments, the neural network-related information includes at least one of a structure of the neural network and a parameter of the neural network.

In some embodiments, the first sub-information includes update information for the first processing method.

In some embodiments, the first device entity includes one or at least two of the following: a base station, a local management function LMF, a network data analytics function NWDAF, a first network element, and a second network element, where the first network element is a network element configured to perform the second processing method, and the second network element is configured to perform at least one of the following: performing information collection on information required by the second processing method, and performing information calculation on the information required by the second processing method.

In some embodiments, the first assistance information meets any one of the following:
the first assistance information is obtained by performing first preset processing on first target information;
the first assistance information is the first target information; and
the first assistance information is the first target information in a case that the terminal performs authentication with the first device entity through a preset interaction authentication procedure, where
the first target information includes related information of a second device entity or information obtained by performing second preset processing on the related information of the second device entity.

In some embodiments, the related information of the second device entity includes at least one of measurement information of the second device entity, implementation information of the second device entity, and statistics information of the second device entity.

In some embodiments, the implementation information of the second device entity includes at least one of antenna configuration information of the second device entity, beam direction information of the second device entity, and location coordinate information of the second device entity; or
the measurement information of the second device entity includes measurement information obtained by the second device entity on an air interface; or
the statistics information of the second device entity includes statistics information obtained by performing long-term measurement on an air interface by the second device entity.

In some embodiments, the related information of the second device entity includes at least one of the following: information about the terminal on a corresponding carrier or bandwidth part; statistics information of one terminal on a plurality of carriers or bandwidth parts; and statistics information of a plurality of terminals.

In some embodiments, the first preset processing includes at least one of the following: performing encryption processing and performing feature abstraction processing by using a preset neural network.

In some embodiments, the second preset processing includes at least one of the following: performing encryption processing and performing feature abstraction processing by using a preset neural network.

In some embodiments, an input of the first processing method includes at least one of the following: terminal antenna information, terminal location information, and a beam feature for measuring beam quality.

In some embodiments, an output of the first processing method is information about beam quality in a plurality of directions.

Information about the beam quality includes a beam identifier, a beam direction, and beam signal strength.

In some embodiments, the second device entity is configured to provide a network service for the terminal, and the second device entity is a base station, a core network device, or another network element other than the base station and the core network device.

In some embodiments, the terminal-related information includes at least one of the following: antenna-related information and location information of the terminal.

In some embodiments, the antenna-related information includes at least one of the following: a panel quantity, a beam quantity, a beam identifier, and a directivity pattern of each beam.

In some embodiments, the second sub-information includes information obtained by aggregating related information of a second device entity with the terminal-related information.

In some embodiments, the information processing apparatus 800 further includes:
a third receiving module, configured to receive a second request sent by the first device entity, where the second request is used to obtain the related information of the second device entity.

In some embodiments, the information processing apparatus 800 further includes:
a third receiving module, configured to receive second assistance information sent by the terminal or the first device entity, where the second assistance information is associated with performing information feature hiding on terminal-related information by the terminal, and the second assistance information is used to determine the second preset processing method.

The information processing apparatus provided in this embodiment of this application can implement the processes in the method embodiment in FIG. 4. To avoid repetition, details are not described herein again.

An embodiment of this application provides an information processing system, and the information processing system includes:
a first device entity, configured to send first information to a terminal; and
a terminal, configured to receive the first information, where the first information includes at least one of the following:
first sub-information used to indicate the first processing method;
first assistance information used for the first processing method;
result information obtained by performing processing based on a second processing method;
an indication used to request second sub-information, where the second sub-information is terminal-related information or information obtained by performing information feature hiding on the terminal-related information; and
an indication used to request third sub-information, where the third sub-information is used to update a third processing method, where
the first information or an operation performed according to the first information is used to determine at least one of the following: beam or channel measurement, beam or channel measurement reporting, and a beam or channel prediction-related operation.

In some embodiments, the information processing system further includes a second device entity;
the terminal is further configured to send second assistance information associated with the information feature hiding to the first device entity;
the first device entity is further configured to send the second assistance information to the second device entity; and
the second device entity is configured to: determine a second preset processing method according to the second assistance information; obtain first target information after processing related information of the second device entity by using the second preset processing method; and send the first target information to the first device entity.

In some embodiments, the information processing system further includes a second device entity;
the terminal is further configured to send the second assistance information associated with the information feature hiding to the second device entity; and
the second device entity is configured to: determine a second preset processing method according to the second assistance information; obtain first target information after processing related information of the second device entity by using the second preset processing method; and send the first target information to the first device entity.

In some embodiments, the second assistance information includes a public key for encryption.

In some embodiments, the first processing method includes a method for processing by using a first neural network, and the first sub-information includes neural network-related information of the first neural network.

In some embodiments, the neural network-related information includes at least one of a structure of the neural network and a parameter of the neural network.

In some embodiments, the first sub-information includes update information for the first processing method.

In some embodiments, the first device entity includes one or at least two of the following: a base station, a local management function LMF, a network data analytics function NWDAF, a first network element, and a second network element, where the first network element is a network element configured to perform the second processing method, and the second network element is configured to perform at least one of the following: performing information collection on information required by the second processing method, and performing information calculation on the information required by the second processing method.

In some embodiments, the first assistance information meets any one of the following:
the first assistance information is obtained by performing first preset processing on first target information;
the first assistance information is the first target information; and
the first assistance information is the first target information in a case that the terminal performs authentication with the first device entity through a preset interaction authentication procedure, where
the first target information includes related information of a second device entity or information obtained by performing second preset processing on the related information of the second device entity.

In some embodiments, the related information of the second device entity includes at least one of measurement information of the second device entity, implementation information of the second device entity, and statistics information of the second device entity.

In some embodiments, the implementation information of the second device entity includes at least one of antenna configuration information of the second device entity, beam direction information of the second device entity, and location coordinate information of the second device entity; or
the measurement information of the second device entity includes measurement information obtained by the second device entity on an air interface; or
the statistics information of the second device entity includes statistics information obtained by performing long-term measurement on an air interface by the second device entity.

In some embodiments, the related information of the second device entity includes at least one of the following: information about the terminal on a corresponding carrier or bandwidth part; statistics information of one terminal on a plurality of carriers or bandwidth parts; and statistics information of a plurality of terminals.

In some embodiments, the first preset processing includes at least one of the following: performing encryption processing and performing feature abstraction processing by using a preset neural network.

In some embodiments, the second preset processing includes at least one of the following: performing encryption processing and performing feature abstraction processing by using a preset neural network.

In some embodiments, an input of the first processing method includes at least one of the following: terminal antenna information, terminal location information, and a beam feature for measuring beam quality.

In some embodiments, an output of the first processing method is information about beam quality in a plurality of directions.

Information about the beam quality includes a beam identifier, a beam direction, and beam signal strength.

In some embodiments, the second device entity is configured to provide a network service for the terminal, and the second device entity is a base station, a core network device, or another network element other than the base station and the core network device.

In a case that the first information is the indication used to request the second sub-information, the terminal is further configured to send the second sub-information to the first device entity.

In some embodiments, the terminal-related information includes at least one of the following: antenna-related information and location information of the terminal.

In some embodiments, the antenna-related information includes at least one of the following: a panel quantity, a beam quantity, a beam identifier, and a directivity pattern of each beam.

In some embodiments, the second sub-information includes information obtained by aggregating related information of a second device entity with the terminal-related information.

The information processing system provided in this embodiment of this application can implement the processes in the method embodiment in FIG. 5. To avoid repetition, details are not described herein again.

The information processing apparatus in this embodiment of this application may be an apparatus, an apparatus or an electronic device with an operating system, or may be a component, an integrated circuit, or a chip in a terminal. The apparatus may be a mobile terminal, or a non-mobile terminal. For example, the mobile device may include but is not limited to the types of the terminal 11 listed above, and the non-mobile terminal may be a server, a Network Attached Storage (NAS), a Personal Computer (PC), a Television (TV), an automated teller machine, or a self-service machine. This is not specifically limited in the embodiments of this application.

The information processing apparatus provided in this embodiment of this application can implement the processes implemented in the method embodiments in FIG. 1 to FIG. 4, and achieve a same technical effect. To avoid repetition, details are not described herein again.

In some embodiments, as shown in FIG. 9, an embodiment of this application further provides a communication device 900, including a processor 901, a memory 902, and a program or an instruction that is stored in the memory 902 and that can be run on the processor 901, where the program or the instruction is executed by the processor 901 to implement the processes of the foregoing information processing method embodiment, and a same technical effect can be achieved. To avoid repetition, details are not described herein again.

An embodiment of this application further provides a terminal, including a processor and a communication interface. The communication interface is configured to receive first information sent by a first device entity, where the first information includes at least one of the following:
first sub-information used to indicate the first processing method;
first assistance information used for the first processing method;
result information obtained by performing processing based on a second processing method;
an indication used to request second sub-information, where the second sub-information is terminal-related information or information obtained by performing information feature hiding on the terminal-related information; and
an indication used to request third sub-information, where the third sub-information is used to update a third processing method, where
the first information or an operation performed according to the first information is used to determine at least one of the following: beam or channel measurement, beam or channel measurement reporting, and a beam or channel prediction-related operation. This terminal embodiment corresponds to the foregoing method embodiment on the terminal side. Each implementation process and implementation of the foregoing method embodiment may be applicable to this terminal embodiment, and a same technical effect can be achieved. FIG. 10 is a schematic structural diagram of hardware of a terminal according to the embodiments of this application.

A terminal 1000 includes but is not limited to at least a part of components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art can understand that the terminal 1000 may further include a power supply (such as a battery) that supplies power to each component. The power supply may be logically connected to the processor 1010 by using a power supply management system, to implement functions such as charging and discharging management, and power consumption management by using the power supply management system. The terminal structure shown in FIG. 10 constitutes no limitation on the terminal, and the terminal may include more or fewer components than those shown in the figure, or combine some components, or have different component arrangements. Details are not described herein.

It should be understood that, in this embodiment of this application, the input unit 1004 may include a Graphics Processing Unit (GPU) 10041 and a microphone 10042, and the graphics processing unit 10041 processes image data of a still picture or a video obtained by an image capture apparatus (such as a camera) in a video capture mode or an image capture mode. The display unit 1006 may include a display panel 10061. The display panel 10061 may be configured in a form such as a liquid crystal display or an organic light-emitting diode. The user input unit 1007 includes a touch panel 10071 and another input device 10072. The touch panel 10071 is also referred to as a touchscreen. The touch panel 10071 may include two parts: a touch detection apparatus and a touch controller. The another input device 10072 may include but is not limited to a physical keyboard, a functional button (such as a volume control button or a power on/off button), a trackball, a mouse, and a joystick. Details are not described herein.

In this embodiment of this application, the radio frequency unit 1001 receives downlink data from a network side device and then sends the downlink data to the processor 1010 for processing; and sends uplink data to the network side device. Usually, the radio frequency unit 1001 includes but is not limited to an antenna, at least one amplifier, a transceiver, a coupler, a low noise amplifier, a duplexer, and the like.

The memory 1009 may be configured to store a software program or an instruction and various data. The memory 109 may mainly include a program or instruction storage area and a data storage area. The program or instruction storage area may store an operating system, and an application or an instruction required by at least one function (for example, a sound playing function or an image playing function). In addition, the memory 1009 may include a high-speed random access memory, and may further include a non-transient memory. The non-transient memory may be a Read-Only Memory (ROM), a Programmable ROM (PROM), an Erasable PROM (EPROM), an Electrically EPROM (EEPROM), or a flash memory, for example, at least a disk storage component, a flash memory component, or another non-transient solid-state storage component.

The processor 1010 may include one or more processing units. In some embodiments, an application processor and a modem processor may be integrated into the processor 1010. The application processor mainly processes an operating system, a user interface, an application, an instruction, or the like. The modem processor mainly processes wireless communication, for example, a baseband processor. It can be understood that, the modem processor may not be integrated into the processor 1010.

The radio frequency unit 1001 is configured to receive first information sent by a first device entity, where the first information includes at least one of the following:
first sub-information used to indicate the first processing method;
first assistance information used for the first processing method;
result information obtained by performing processing based on a second processing method;
an indication used to request second sub-information, where the second sub-information is terminal-related information or information obtained by performing information feature hiding on the terminal-related information; and
an indication used to request third sub-information, where the third sub-information is used to update a third processing method, where
the first information or an operation performed according to the first information is used to determine at least one of the following: beam or channel measurement, beam or channel measurement reporting, and a beam or channel prediction-related operation.

In some embodiments, the first processing method includes a method for processing by using a first neural network, and the first sub-information includes neural network-related information of the first neural network.

In some embodiments, the neural network-related information includes at least one of a structure of the neural network and a parameter of the neural network.

In some embodiments, the first sub-information includes update information for the first processing method.

In some embodiments, the first device entity includes one or at least two of the following: a base station, a local management function LMF, a network data analytics function NWDAF, a first network element, and a second network element, where the first network element is a network element configured to perform the second processing method, and the second network element is configured to perform at least one of the following: performing information collection on information required by the second processing method, and performing information calculation on the information required by the second processing method.

In some embodiments, the first assistance information meets any one of the following:
the first assistance information is obtained by performing first preset processing on first target information;
the first assistance information is the first target information; and
the first assistance information is the first target information in a case that the terminal performs authentication with the first device entity through a preset interaction authentication procedure, where
the first target information includes related information of a second device entity or information obtained by performing second preset processing on the related information of the second device entity.

In some embodiments, the related information of the second device entity includes at least one of measurement information of the second device entity, implementation information of the second device entity, and statistics information of the second device entity.

In some embodiments, the implementation information of the second device entity includes at least one of antenna configuration information of the second device entity, beam direction information of the second device entity, and location coordinate information of the second device entity; or
the measurement information of the second device entity includes measurement information obtained by the second device entity on an air interface; or
the statistics information of the second device entity includes statistics information obtained by performing long-term measurement on an air interface by the second device entity.

In some embodiments, the related information of the second device entity includes at least one of the following: information about the terminal on a corresponding carrier or bandwidth part; statistics information of one terminal on a plurality of carriers or bandwidth parts; and statistics information of a plurality of terminals.

In some embodiments, the first preset processing includes at least one of the following: performing encryption processing and performing feature abstraction processing by using a preset neural network.

In some embodiments, the second preset processing includes at least one of the following: performing encryption processing and performing feature abstraction processing by using a preset neural network.

In some embodiments, an input of the first processing method includes at least one of the following: terminal antenna information, terminal location information, and a beam feature for measuring beam quality.

In some embodiments, an output of the first processing method is information about beam quality in a plurality of directions.

Information about the beam quality includes a beam identifier, a beam direction, and beam signal strength.

In some embodiments, the second device entity is configured to provide a network service for the terminal, and the second device entity is a base station, a core network device, or another network element other than the base station and the core network device.

In some embodiments, the information processing apparatus further includes:
a first sending module, configured to send a first request to the first device entity, where the first request is used to obtain the first information.

In some embodiments, the first request carries second assistance information associated with the information feature hiding, and the second assistance information is used to determine the second sub-information.

In some embodiments, the second assistance information includes a public key for encryption.

In a case that the first information is the indication used to request the second sub-information, the radio frequency unit 1001 is further configured to send the second sub-information to the first device entity.

In some embodiments, the terminal-related information includes at least one of the following: antenna-related information and location information of the terminal.

In some embodiments, the antenna-related information includes at least one of the following: a panel quantity, a beam quantity, a beam identifier, and a directivity pattern of each beam.

In some embodiments, the second sub-information includes information obtained by aggregating related information of a second device entity with the terminal-related information.

In a case that the first information is the result information obtained by performing processing based on the second processing method, the radio frequency unit 1001 is further configured to send, to the first device entity, a beam measurement result and the information obtained by performing information feature hiding on the terminal-related information, where the beam measurement result and the information obtained by performing information feature hiding on the terminal-related information are used to determine the result information.

In a case that the third processing method includes a method for processing by using a third neural network and the first information is the indication used to request the third sub-information, the radio frequency unit 1001 is further configured to send the third sub-information to the first device entity, where the third sub-information is network parameter update information of the third neural network.

In some embodiments, the network parameter update information is obtained by training the third neural network based on a plurality of beam measurement results and terminal implementation.

An embodiment of this application further provides a network side device, including a processor and a communication interface. The communication interface is configured to send first information to a terminal, where the first information includes at least one of the following:
first sub-information used to indicate the first processing method;
first assistance information used for the first processing method;
result information obtained by performing processing based on a second processing method;
an indication used to request second sub-information, where the second sub-information is terminal-related information or information obtained by performing information feature hiding on the terminal-related information; and an indication used to request third sub-information, where the third sub-information is used to update a third processing method, where
the first information or an operation performed according to the first information is used to determine at least one of the following: beam or channel measurement, beam or channel measurement reporting, and a beam or channel prediction-related operation. This network side device embodiment corresponds to the foregoing method embodiment on the network side device. Each implementation process and implementation of the foregoing method embodiment may be applicable to this network side device embodiment, and a same technical effect can be achieved.

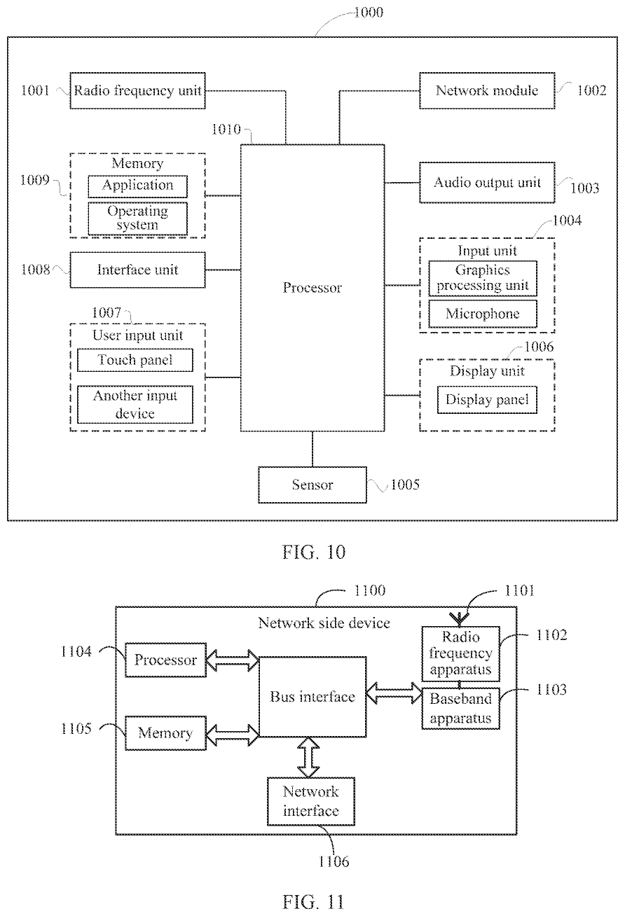

An embodiment of this application further provides a network side device. As shown in FIG. 11, a network side device 1100 includes an antenna 1101, a radio frequency apparatus 1102, and a baseband apparatus 1103. The antenna 1101 is connected to the radio frequency apparatus 1102. In an uplink direction, the radio frequency apparatus 1102 receives information by using the antenna 1101, and sends the received information to the baseband apparatus 1103 for processing. In a downlink direction, the baseband apparatus 1103 processes to-be-sent information, and sends the information to the radio frequency apparatus 1102. The radio frequency apparatus 1102 processes the received information and then sends the information by using the antenna 1101.

The frequency band processing apparatus may be located in the baseband apparatus 1103. The method performed by the network side device in the foregoing embodiment may be implemented in the baseband apparatus 1103. The baseband apparatus 1103 includes a processor 1104 and a memory 1105.

The baseband apparatus 1103 may include, for example, at least one baseband board. where a plurality of chips are disposed on the baseband board. As shown in FIG. 11, one chip is, for example, the processor 1104, which is connected to the memory 1105, so as to invoke a program in the memory 1105 to perform operations of the network side device shown in the foregoing method embodiment.

The baseband apparatus 1103 may further include a network interface 1106, configured to exchange information with the radio frequency apparatus 1102. For example, the interface is a Common Public Radio Interface (CPRI).

The network side device in this embodiment of this application further includes an instruction or a program that is stored in the memory 1105 and that can be run on the processor 1104. The processor 1104 invokes the instruction or the program in the memory 1105 to perform the method performed by the modules shown in FIG. 7 or FIG. 3, and a same technical effect is achieved. To avoid repetition, details are not described herein again.

An embodiment of this application further provides a readable storage medium. The readable storage medium stores a program or an instruction, and when the program or the instruction is executed by a processor, the processes of the foregoing information processing method embodiment are implemented and a same technical effect can be achieved. To avoid repetition, details are not described herein again.

The processor is a processor in the electronic device in the foregoing embodiment. The readable storage medium includes a computer-readable storage medium, such as a computer Read-only Memory (ROM), a Random Access Memory (RAM), a magnetic disk, or an optical disc.

An embodiment of this application further provides a chip. The chip includes a processor and a communication interface, the communication interface is coupled to the processor, and the processor is configured to run a program or an instruction to implement the processes of the foregoing information processing method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program product. The computer program product is stored in a storage medium, and the computer program product is executed by at least one processor to implement the processes of the foregoing information processing method embodiment, and a same technical effect can be achieved. To avoid repetition, details are not described herein again.

It should be noted that, in this specification, the terms “include”, “comprise”, or their any other variant is intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element limited by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (such as a ROM/RAM, a hard disk, or an optical disc), and includes several instructions for instructing a terminal (which may be a mobile phone, a computer, a server, an air conditioner, a base station, or the like) to perform the methods described in the embodiments of this application.

The embodiments of this application are described above with reference to the accompanying drawings, but this application is not limited to the above specific implementations, and the above specific implementations are only illustrative and not restrictive. Under the enlightenment of this application, those of ordinary skill in the art can make many forms without departing from the purpose of this application and the protection scope of the claims, all of which fall within the protection of this application.

1. A method for information processing, comprising:
receiving, by a terminal, first information sent by a first device entity, wherein the first information comprises at least one of the following:
first sub-information used to indicate a first processing method;
first assistance information used for the first processing method;
result information obtained by performing processing based on a second processing method;
an indication used to request second sub-information, wherein the second sub-information is terminal-related information or information obtained by performing information feature hiding on the terminal-related information; or
an indication used to request third sub-information, wherein the third sub-information is used to update a third processing method,
wherein:
the first information or an operation performed according to the first information is used to determine at least one of the following: beam or channel measurement, beam or channel measurement reporting, or a beam or channel prediction-related operation;
the first processing method comprises a method for processing by using a first neural network, the first sub-information comprises neural network-related information of the first neural network, and the neural network-related information comprises at least one of a structure of the neural network or a parameter of the neural network;
the terminal-related information comprises at least one of the following: antenna-related information or location information of the terminal, and the antenna-related information comprises at least one of the following: a panel quantity, a beam quantity, a beam identifier, or a directivity pattern of each beam; and
the second sub-information comprises information obtained by aggregating related information of a second device entity with the terminal-related information.

2. The method according to claim 1, wherein the first device entity comprises one or at least two of the following: a base station, a local management function LMF, a network data analytics function NWDAF, a first network element, and a second network element,
wherein the first network element is a network element configured to perform the second processing method, and the second network element is configured to perform at least one of the following: performing information collection on information required by the second processing method, or performing information calculation on the information required by the second processing method.

3. The method according to claim 1, wherein the first assistance information meets any one of the following:
the first assistance information is obtained by performing first preset processing on first target information;
the first assistance information is the first target information; or
the first assistance information is the first target information when the terminal performs authentication with the first device entity through a preset interaction authentication procedure, wherein:
the first target information comprises related information of a second device entity or information obtained by performing second preset processing on the related information of the second device entity;
the related information of the second device entity comprises at least one of measurement information of the second device entity, implementation information of the second device entity, or statistics information of the second device entity;
the related information of the second device entity comprises at least one of the following: information about the terminal on a corresponding carrier or bandwidth part, statistics information of one terminal on a plurality of carriers or bandwidth parts, or statistics information of a plurality of terminals;
the first preset processing comprises at least one of the following: performing encryption processing or performing feature abstraction processing by using a preset neural network;
the second preset processing comprises at least one of the following: performing encryption processing or performing feature abstraction processing by using a preset neural network; and
the second device entity is configured to provide a network service for the terminal, and the second device entity is a base station, a core network device, or another network element other than the base station and the core network device.

4. The method according to claim 3, wherein the implementation information of the second device entity comprises at least one of antenna configuration information of the second device entity, beam direction information of the second device entity, or location coordinate information of the second device entity; or
the measurement information of the second device entity comprises measurement information obtained by the second device entity on an air interface; or
the statistics information of the second device entity comprises statistics information obtained by performing long-term measurement on an air interface by the second device entity.

5. The method according to claim 1, wherein an input of the first processing method comprises at least one of the following: terminal antenna information, terminal location information, or a beam feature for measuring beam quality; and
an output of the first processing method is information about beam quality in a plurality of directions.

6. The method according to claim 5, wherein information about the beam quality comprises a beam identifier, a beam direction, and beam signal strength.

7. The method according to claim 3, wherein before receiving, by the terminal, the first information sent by the first device entity, the method further comprises:
sending, by the terminal, a first request to the first device entity, wherein the first request is used to obtain the first information.

8. The method according to claim 7, wherein the first request carries second assistance information associated with the information feature hiding, and the second assistance information is used to determine the second sub-information.

9. The method according to claim 8, wherein the second assistance information comprises a public key for encryption.

10. The method according to claim 1, wherein when the first information is the indication used to request the second sub-information, after receiving, by the terminal, the first information sent by the first device entity, the method further comprises:
sending, by the terminal, the second sub-information to the first device entity.

11. The method according to claim 1, wherein when the first information is the result information obtained by performing processing based on the second processing method, before the receiving, by a terminal, first information sent by a first device entity, the method further comprises:
sending, by the terminal to the first device entity, a beam measurement result and the information obtained by performing information feature hiding on the terminal-related information, wherein the beam measurement result and the information obtained by performing information feature hiding on the terminal-related information are used to determine the result information.

12. The method according to claim 1, wherein when the third processing method comprises a method for processing by using a third neural network and the first information is the indication used to request the third sub-information, after the receiving, by a terminal, first information sent by a first device entity, the method further comprises:
sending, by the terminal, the third sub-information to the first device entity, wherein the third sub-information is network parameter update information of the third neural network.

13. The method according to claim 12, wherein the network parameter update information is obtained by training the third neural network based on a plurality of beam measurement results and terminal implementation.

14. A method for information processing, comprising:
sending, by a first device entity, first information to a terminal, wherein the first information comprises at least one of the following:
first sub-information used to indicate a first processing method;
first assistance information used for the first processing method;
result information obtained by performing processing based on a second processing method;
an indication used to request second sub-information, wherein the second sub-information is terminal-related information or information obtained by performing information feature hiding on the terminal-related information; or
an indication used to request third sub-information, wherein the third sub-information is used to update a third processing method,
wherein the first information or an operation performed according to the first information is used to determine at least one of the following: beam or channel measurement, beam or channel measurement reporting, or a beam or channel prediction-related operation; an
the first processing method comprises a method for processing by using a first neural network. the first sub-information comprises neural network-related information of the first neural network, and the neural network-related information comprises at least one of a structure of the neural network or a parameter of the neural network.

15. The method according to claim 14, wherein the first device entity comprises one or at least two of the following: a base station, a local management function (LMF), a network data analytics function (NWDAF), a first network element, and a second network element, wherein the first network element is a network element configured to perform the second processing method, and the second network element is configured to perform at least one of the following: performing information collection on information required by the second processing method, or performing information calculation on the information required by the second processing method.

16. The method according to claim 14, wherein the first assistance information meets any one of the following:
the first assistance information is obtained by performing first preset processing on first target information;
the first assistance information is the first target information; or
the first assistance information is the first target information when the terminal performs authentication with the first device entity through a preset interaction authentication procedure,
wherein the first target information comprises related information of a second device entity or information obtained by performing second preset processing on the related information of the second device entity.

17. The method according to claim 14. wherein when the third processing method is a method for processing by using a third neural network, the method further comprises:
performing, by the first device entity, training update on the third neural network according to third sub-information sent by each terminal,
wherein the third sub-information is determined by each terminal according to a beam measurement result and the terminal-related information.

18. A method for information processing, comprising:
sending, by a second device entity, first target information to a first device entity, wherein the first target information comprises related information of the second device entity or information obtained by performing second preset processing on the related information of the second device entity, and the first target information is used to determine first information sent by the first device entity to a terminal; and the first information comprises at least one of the following:
first sub-information used to indicate a first processing method;
first assistance information used for the first processing method; or
result information obtained by performing processing based on a second processing method,
wherein the first information or an operation performed according to the first information is used to determine at least one of the following: beam or channel measurement, beam or channel measurement reporting, and a beam or channel prediction-related operation; and
the first processing method comprises a method for processing by using a first neural network, the first sub-information comprises neural network-related information of the first neural network, and the neural network-related information comprises at least one of a structure of the neural network and a parameter of the neural network.

19. The method according to claim 18, wherein before sending, by the second device entity, the related information of the second device entity to the first device entity, the method further comprises:
receiving, by the second device entity, a second request sent by the first device entity, wherein the second request is used to obtain the related information of the second device entity.

20. The method according to claim 18, wherein before sending, by the second device entity, the first target information to the first device entity, the method further comprises:
receiving, by the second device entity, second assistance information sent by the terminal or the first device entity, wherein the second assistance information is associated with performing information feature hiding on terminal-related information by the terminal, and the second assistance information is used to determine the second preset processing method.
